(19) United States
(12) Patent Application Publication
(10) Pub. No.: US 2020/0230931 A1
(43) Pub. Date: Jul. 23, 2020

(54) VEHICLE INTERIOR PANEL WITH BACKING LAYER

(71) Applicant: Faurecia Interior Systems, Inc., Auburn Hills, MI (US)

(72) Inventor: Carl SMITH, Fenton, MI (US)

(21) Appl. No.: 16/839,471

(22) Filed: Apr. 3, 2020

Related U.S. Application Data
(62) Division of application No. 15/493,895, filed on Apr. 21, 2017.

(51) Int. Cl. B32B 27/22; B29C 44/14; B29C 37/00; B29C 41/18; B32B 27/30; B32B 27/06; B32B 5/20

(52) U.S. Cl. CPC B32B 27/22; B29C 44/145; B29C 37/0032; B29L 2009/00; B32B 27/304; B32B 27/065; B32B 5/20; B29C 41/18

(57) ABSTRACT

A vehicle interior panel includes a decorative skin layer and a backing layer. The backing layer can include a barrier material that helps prevent outgassing of a plasticizer of the decorative skin layer in a direction toward an underlying substrate of the panel. The backing layer can be formed by vacuum coating and/or formed while a slush molded layer remains on a slush molding tool surface on which it was formed. in some cases, a slush molding tool thus finds new uses in a vacuum coating process or in some other process apart from slush molding.

### TECHNICAL FIELD

The present disclosure relates generally to vehicle interior panels and is particularly pertinent to multi-layer panel constructions that include a plasticizer.

### BACKGROUND

Modem vehicle interior components are constructed largely from polymer-based materials, which combine diverse and customizable material properties with cost and weight advantages over other types of materials. Polymer-based materials can also he formed into almost any shape by heating to relatively low temperatures then shaping and cooling the material while in the desired shaped. One property of polymer-based materials that can be customized via material additives is material rigidity. For instance, many moldable plastics may he considered semi-rigid in their unmodified state i.e., more flexible than metals but generally of sufficient stiffness to support their own weight. Such materials can be modified to he more rigid by blending them with a higher stiffness additive such as glass fibers or mineral fillers. Polymer-based materials can also be modified to be less rigid by blending them with a lower stiffness additive, such as an elastomer. Additive use in polymers generally involves a material property trade-off. For example, an additive-induced stiffness increase may result in a corresponding impact strength decrease, or vice versa.

U.S. Patent No. 6,673,288 to Dargavell et al. discloses an apparatus and process for making thin-walled articles or skins from plastic materials such as thermoplastic urethane (TPU), thermoplastic olefin (TPO), or polyvinylchloride (PVC). The process includes a previously known slush molding technique, and the apparatus includes a multi-element moving vacuum chamber (MEMVC). The MEMVC provides a partial vacuum or reduced pressure environment within the slush molding cavity, at the opposite side of the slush molding surface, and/or at the opposite side of the powder box during rotation of the mold and powder box and the associated deposition of the plastic powder on the molding surface, where the skin is formed. While Dargavell does not explain any particular cause-and-effect relationship, evacuation of one or more regions of the MEMVC is said to reduce defects such as pin holes and thickness variation in the molded article.

### SUMMARY

In accordance with an embodiment, an interior panel for use in a vehicle includes comprising a substrate, a decorative skin layer disposed over the substrate, and a backing layer interposed between the substrate and the decorative skin layer. The decorative skin layer has a visible outer side facing an interior of a passenger cabin of the vehicle when installed in the vehicle and includes a layer of plasticized polymeric material having a polymeric material and a plasticizer distributed within the polymeric material. The backing layer comprises a barrier material. The plasticizer has a solubility in the barrier material that is less than a solubility of the plasticizer in the polymeric material.

In some embodiments, the interior panel includes a foam layer interposed between the substrate and the backing layer.

In some embodiments, the backing layer is disposed on an inner side of the decorative skin layer that is opposite the outer side of the decorative skin layer and facing toward the substrate.

In some embodiments, the polymeric material comprises polyvinylchloride.

In some embodiments, the barrier material comprises a cross-linked polymeric material.

In some embodiments, the barrier material comprises a semi-crystalline polymeric material.

In accordance with another embodiment, a method of making an interior panel for a vehicle includes the steps of: providing a layer of plasticized polymeric material comprising a polymeric material and a plasticizer distributed within the polymeric material, and vacuum coating the layer of plasticized polymeric material with a barrier material. The plasticizer has a solubility in the barrier material that is less than a solubility of the plasticizer in the polymeric material, and the layer of plasticized polymeric material forms at least a portion of a decorative skin layer of the interior panel.

In some embodiments, the layer of plasticized polymeric material is formed by slush molding and has an outer side formed on a slush molding tool surface and an opposite inner side that is vacuum coated in the step of vacuum coating.

In some embodiments, the method includes molding the layer of plasticized polymeric material on a molding tool surface in the step of providing the layer of plasticized polymeric material, and removing the layer of plasticized polymeric material from the molding tool surface. The step of vacuum coating is performed before the step of removing.

In some embodiments, the step of vacuum coating comprises powder coating the layer of plasticized polymeric material with the barrier material.

In some embodiments, the method includes disposing the vacuum coated layer of material over a substrate to form the interior panel.

In some embodiments, the method includes disposing a foam layer between a substrate and the barrier material.

In some embodiments, the method includes a foam-in-place process.

In accordance with another embodiment, a method of making an interior panel for a vehicle includes the steps of: slush molding a layer of the interior panel on a slush molding tool surface, disposing a backing layer over the slush molded layer while the slush molded layer is on the slush molding tool surface to form a multi-layer material on the slush molding tool surface, and removing the multi-layer material from the slush molding tool surface. The backing layer is formed from a material different from the slush molded layer, and the multi-layer material is configured to be disposed over a substrate as part of the interior panel.

In some embodiments, the slush molded layer comprises a plasticized polymeric material and the baking layer comprises a barrier material. A plasticizer of the plasticized polymeric material is less soluble than in the barrier material than in a polymeric material of the plasticized polymeric material.

In some embodiments, disposing the backing layer over the slush molded layer includes vacuum coating the backing layer over the slush molded layer.

In some embodiments, disposing the backing layer over the slush molded layer includes powder coating an exposed side of the slush molded layer.

In some embodiments, powder coating an exposed side of the slush molded layer does not include rotational slush molding.

Various aspects, embodiments, examples, features and alternatives set forth in the preceding paragraphs, in the claims, and/or in the following description and drawings may be taken independently or in any combination thereof For example, features disclosed in connection with one embodiment are applicable to all embodiments in the absence of incompatibility of features.

### DESCRIPTION OF THE DRAWINGS

One or more embodiments will hereinafter be described in conjunction with the appended drawings, wherein like designations denote like elements, and wherein:

FIG. 1 is a cross-sectional view of a portion of a vehicle interior panel that includes a decorative skin layer and a backing layer;

FIG. 2 is a schematic side view of an illustrative coating system for use in forming the backing layer of the interior panel of FIG. 1;

FIG. 3 illustrates the system of FIG. 2 during formation of a coating chamber between a molding tool and a closure;

FIG. 4 illustrates the coating system during evacuation of a surge tank;

FIG. 5 illustrates the coating system during evacuation of the coating chamber; and

FIG. 6 illustrates the coating system during coating of a previously molded article with a coating material in powder form.

### DETAILED DESCRIPTION OF EMBODIMENT(S)

Described below is a vehicle interior panel that includes a decorative skin layer and a backing layer, along with a method and system for making it. The backing layer can act as a barrier to help prevent outgassing of a plasticizer of the decorative skin layer. The backing layer can be formed by vacuum coating and/or disposed over a slush molded layer before it is removed from a slush molding tool surface on which it was formed. In some cases, a slush molding tool thus finds new uses in a process apart from slush molding.

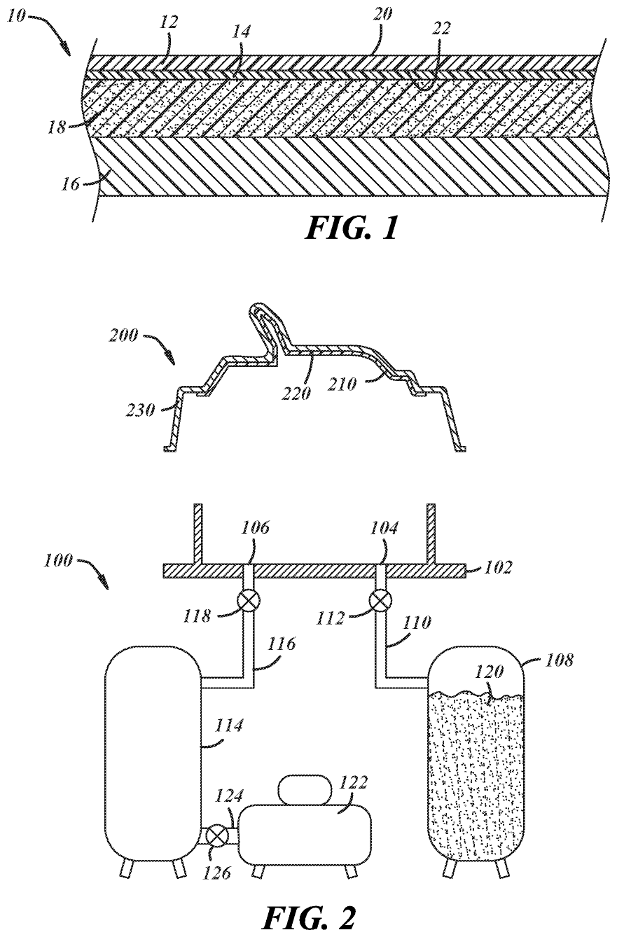

FIG. 1 is a cross-sectional view of a portion of one example of a vehicle interior panel 10 that includes a decorative skin layer 12 and a backing layer 14 arranged together over a substrate 16 and an interposed foam layer 18. As described further below, the backing layer 14 may be configured to help prevent outgassing or other migration or diffusion of a plasticizer from the decorative skin layer 12. The multi-layer vehicle interior panel 10 may be any type of panel having a visible outer side 20 exposed to the interior of a vehicle passenger cabin when installed in the vehicle, such as an instrument panel, door panel, console lid, arm rest, pillar cover, steering wheel panel, seat covering, etc.

The substrate 16 is the most rigid of the illustrated panel layers and thereby provides structural support for the overlying layers at desired locations within the vehicle via attachment to other vehicle structures. Fiberglass-reinforced polypropylene having a thickness of 2 mm to 4 mm is one example of a suitable substrate 16, but various other types of materials and material combinations and/or different thickness ranges can be employed in a similar manner.

The foam layer 18 can assist the skin layer 12 in providing desired tactile characteristics to the panel 10 in the form of elastic cushioning that compresses when a force is applied to the outer side 20 of the panel 10 and decompresses when the force is removed to return the skin layer to its original position. The foam layer 18 can also provide sound deadening and/or have a non-uniform thickness to fill space between the skin layer 12 and the substrate 16 when the respective contours of the skin layer and substrate are different from each other. In one example, the foam layer 18 is a backfilled or foam-in-place material layer formed by introducing a liquid foam precursor material into a space between the skin layer 12 and the substrate 16, with at least the skin layer constrained in the desired final shape in a foam molding tool. The foam precursor material expands to fill and take the shape of the space and cures to form the foam layer 18. One suitable foam layer material is polyurethane foam formed from a liquid precursor material comprising a polyol and a diisocyanate. Other foam materials (e.g., polyolefin-based) are possible, as are other foaming processes (e.g., use of a heat-activated foaming agent). The foam layer 18 may range in thickness from 1 mm to 10 mm, can be separately provided and adhered with adjacent material layers, or can be omitted altogether.

The decorative skin layer 12 is the outermost layer of the panel 10 and includes the visible outer side 20 of the panel with an opposite inner side 22 facing toward the substrate 16. The primary function of the skin layer 12 is to provide aesthetic appeal to occupants of the passenger cabin, including desirable visual characteristics such as color, shape, and texture. The skin layer 12 may thus include design features visible at the outer side 20, such as an embossed pattern or a paint film in the desired color. The skin layer 12 may also at least partly provide the panel 10 with desired tactile characteristics in the likeness of furniture upholstery, such as a soft-touch or smooth feel. In some cases, the skin layer 12 is formed with synthetic materials configured with aesthetic characteristics imitating other more expensive materials such as leather.

The decorative skin layer 12 as a stand-alone component is generally more flexible than the structure-providing substrate 16 and the cushion-providing foam layer 18 and derives part of its name (i.e., skin) from its relatively small thickness as a portion of the overall thickness of the panel 10. The skin layer 12 may provide 25% or less of the total thickness of the panel 10, such as 5-15% or 10-20%, and may range in thickness from 0.5 mm to 2.0 mm. The thickness of the skin layer 12 is preferably minimized to 1.0 mm or less when possible. The skin layer 12 may thus be considered a film, particularly when formed from a polymer-based material such as TPO, TPU, or PVC, and is generally not capable of supporting its own weight when extended horizontally, similar to a piece of fabric.

The decorative skin layer 12 may include or be formed from a layer of plasticized polymeric material, which includes a polymeric material and a plasticizer distributed within the polymeric material. The polymeric material is preferably a thermoplastic and can be any homopolymer, copolymer, or an alloy or mixture thereof. The plasticizer is blended with the polymeric material with the primary purpose of softening or flexibilizing the polymeric material. In quantitative terms, a blend of the polymeric material and the plasticizer has a lower elastic modulus, flexural modulus, or hardness than the unmodified polymeric material. In qualitative terms, the plasticizer can change an unmodified polymeric material such as PVC from semi-rigid to rubbery, or cause a rubbery polymer such as a thermoplastic elastomer (TPE) to become softer. The polymeric material may contain additional additives such as colorants, flame retardants, compatibillizers, UV-stabilizers, heat stabilizers, or reinforcing fillers, for example. In some cases, an additive provides a plasticizing function as well as one or more other property altering functions, such as flame retardancy.

Not all modulus-reducing additives are considered plasticizers. The plasticized polymeric material also has a lower glass-transition temperature (T_{g}) than the unmodified polymeric material. The plasticizer may also include the following characteristics: it is an organic compound, it is a liquid at room temperature, it has a molecular weight at least an order of magnitude lower than the polymeric material, and/or it is non-polymeric. Many plasticizers meet all of these qualifiers. Suitable plasticizers may include phthalate esters, trimellitates, adipates, sebacates, maleates, oils, oligomers, or low molecular weight polymers. Suitability depends in part on compatibility between the polymeric material and the plasticizer—i.e., they must be sufficiently miscible or soluble with each other to remain generally homogenous as a solid blend.

As noted above, the backing layer 14 may be configured as a barrier layer that is configured to help prevent outgassing, migration, diffusion of the plasticizer from the decorative skin layer 12. one negative characteristic of a plasticized polymeric material is a tendency for its homogeneity to decrease over time i.e., the polymeric material and plasticizer will begin to separate. This separation accelerates during periods of elevated temperature, a condition often experienced in vehicle interiors. In the illustrated example, the plasticizer component will tend to migrate toward one or both of the opposite surfaces or sides 20, 22 of the skin layer 12, where it may revert to a thin film of liquid and/or evaporate. The resulting loss of plasticizer from the plasticized polymeric material leads to multiple problems, including loss of the desired flexibility or softness of the skin layer 12, condensation of evaporated plasticizer in undesirable locations in the passenger cabin of the vehicle (e.g., on the windshield), and/or weakening of the bond between the skin layer and the foam layer 18 or substrate 16. A backing layer 14 that includes or is formed from a barrier material addresses at least the latter problem.

In the illustrated example, the backing layer 14 is disposed directly adjacent the inner side 22 of the decorative skin layer 12, but it can be located anywhere between the skin layer 12 and substrate 16 (or foam layer 18 where included) to perform its barrier function. The backing layer 14 may have a thickness the same as or less than that of the skin layer 12 and may be formed from or include a barrier material that acts as a barrier to the plasticizer of the skin layer. The barrier material is configured or selected so that the plasticizer is less soluble in the barrier material than in the polymeric material of the plasticized polymeric material. The effect of the barrier material is to slow or substantially prevent the migration of plasticizer from the skin layer 12 in the direction of the substrate 16, thereby helping to prevent any delamination of the skin layer from the underlying layers that would otherwise be caused by the plasticizer.

One example of a suitable barrier material for use as or in the backing layer 14 is a material having a solubility parameter such that: In other words, the difference in the solubility parameters (δ) of the barrier material and the plasticizer is greater than the difference in the solubility parameters of the polymeric material and the plasticizer. Of course, solubility of one material with another may be evaluated in other ways such as determination of saturation points or other empirical methods.

The barrier material may also include or be formed from a cross-linked polymer, such as an epoxy or a curable polyurethane or acrylic. The cross-links in such a material help prevent the plasticizer from migrating along the spaces between adjacent polymer molecules. In another embodiment, the barrier material includes or is formed from a semi-crystalline polymer, such as certain polyolefins or polyamides. Semi-crystalline polymers include amorphous and crystalline regions, and the crystalline regions can help prevent the plasticizer from migrating along spaces between adjacent polymer molecules due to the tightly packed crystalline structure. The barrier layer could also include or be formed from non-polymeric materials that are completely impervious to the plasticizer, such as metals, ceramics, minerals, etc., with requisite attention given to maintaining the desired flexibility of the skin layer 12 when backed by the backing layer 14.

Adhesion with the foam layer 18 or other adhesive disposed between the skin layer 12 and substrate 16 must also be considered. In one particular example, the backing layer 14 is formed from or includes a non-foam cross-linked polyurethane film as the barrier material. The polyurethane composition promotes adhesion with a polyurethane-based foam layer 18, and the cross-linking helps provide barrier properties against the plasticizer of the skin layer 12.

A system and method for making the above-described vehicle interior panel will now be described. FIG. 2 schematically illustrates an exemplary coating system 100 configured to provide a backing layer on a molded article prior to demolding the article. The illustrated system 100 is configured to engage a slush molding tool 200 while a previously slush molded layer of material 210 remains on molding surface 220 of the tool. The slush molding process is not illustrated here, but generally includes attaching a powder box to the molding tool 200 with the bare molding surface 220 of a shell 230 of the tool facing down and an opening of the powder box facing up. The tool 200 and attached powder box are rotated 360 degrees about a horizontal axis while the molding surface 220 is at an elevated temperature. Plastic powder from the powder box falls onto the molding surface 220 during this rotation and forms a molten layer of plastic that sticks to the molding surface, Excess unmelted powder is returned to the powder box toward the end of the rotation. The molten layer cools to form the slush molded layer of material 210. In a conventional process, the slush molded layer 210 is removed from the tool 200 and may be used as the decorative skin layer of a vehicle interior panel.

The illustrated coating system 100 includes a closure 102 with a coating material port 104 and a vacuum port 106. The material port 104 is in selective fluid communication with a coating material source 108, such as via the illustrated conduit 110, which has a valve 112 located therealong to selectively connect the coating material source with the port 104. The vacuum port 106 is in selective fluid communication with a vacuum source 114, such as via the illustrated conduit 116, which has a valve 118 located therealong to selectively connect the vacuum source with the port 106.

The illustrated coating material source 108 is a container with an internal volume that holds the desired backing layer material 120, such as the above-described barrier material, in flowable form. In this example, the material 120 is in powder form. In other examples, the material may be in liquid form, For instance, the backing layer material may be in a solvent-based suspension or solution. The internal volume of the coating material source 108 may be pressurized during use.

The illustrated vacuum source 114 is also a container with an internal volume. In this case, the vacuum source 114 is a surge tank configured with a volume sized to sufficiently evacuate a cavity between the molding tool 200 and closure 102 as further described below. The surge tank 114 is in selective fluid communication with a vacuum pump 122 via a conduit 124 and valve 126.

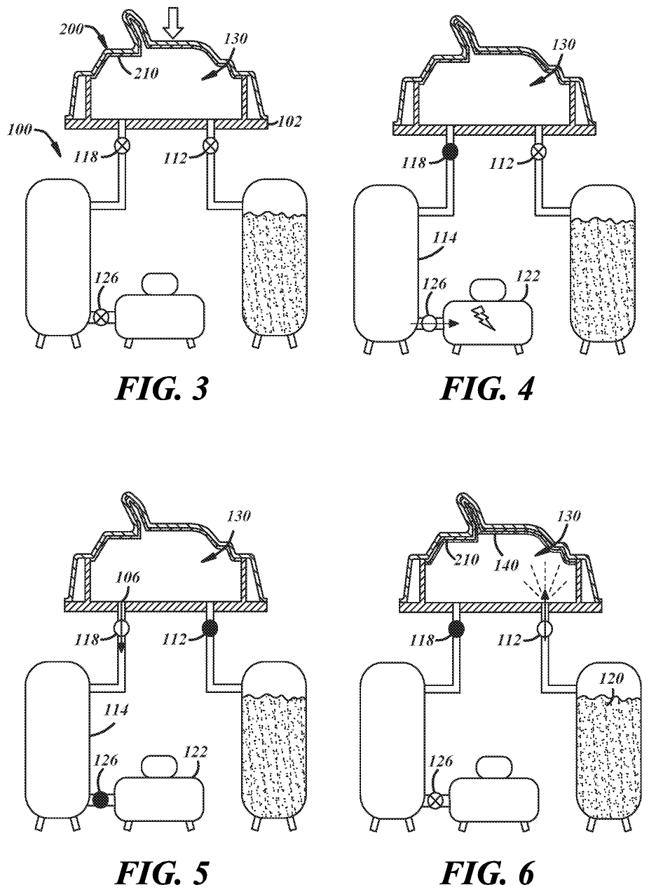

Operation of the illustrated system 100, which may be referred to as a powder barrier application process (PBAP), is summarized in FIGS. 3-6, in which closed valves are illustrated as filled circles and open valves as unfilled circles. Operation generally includes first bringing the closure 102 and the molding tool 200 together to form a coating chamber or cavity 130 therebetween with the previously molded layer 210 of skin material still on the mold, then evacuating the cavity 130, followed by flowing the coating material 120 into the evacuated cavity. Formation of the cavity 130 is shown in FIG. 3, during which the valves 112, 118, 126 may be either open or closed.

Evacuation of the cavity 130 in this example is performed by first evacuating the surge tank 114, which is completed with the vacuum pump 122 energized, the valve 126 open, and the valve 118 closed. The valve 112 may be either open or closed at this stage, which is illustrated in FIG. 4. In some embodiments, the surge tank 114 is evacuated before the cavity 130 is formed. As shown in FIG. 5, the cavity 130 is then evacuated via the vacuum port 106 by opening the corresponding valve 118. The coating valve 112 and vacuum pump valve 126 are closed during this stage. The vacuum pump valve 126 may be a check valve that opens while the pump 122 is energized and closes when the pump is de-energized.

As shown in FIG. 6, coating material 120 from the coating material source 108 is then drawn into the evacuated cavity 130 to coat its surfaces, including the exposed side of the molded skin 210. The vacuum source valve 118 is first closed to maintain the vacuum created in the cavity 130 in FIG. 5, then the coating valve 112 is opened. As noted above, the coating material source 108 may be pressurized to boost the pressure differential between its internal volume and the cavity. A coating layer 140 is thus formed over the previously molded layer 210, which in some embodiments is the layer of plasticized polymeric material of the decorative skin layer 12 as previously discussed.

The coating layer 140 is cured or otherwise solidified to form the above-described backing layer 14. In one embodiment, the coating material 120 is in powder form and has a thermoplastic component that melts or softens when it contacts the surface of the previously molded layer 210. For instance, the illustrated coating process may be performed immediately after the slush molding process with residual heat used to melt or soften the coating material on contact. In some cases, the coating process is performed before the molded layer 210 is fully solidified. Alternatively, the molded layer 210 may be additionally heated between formation of the molded layer 210 and the coating process. In another embodiment, the coating material is in solution form with the backing layer material dispersed in a liquid solvent that evaporates after the coating step of FIG. 6. Residual heat from the previously molding process may be used to accelerate the evaporation in that case. Residual heat or post-heating may be used to cure or form cross-links in the coating layer 140 in some embodiments.

It should also be noted that the order of valve operation, evacuation, and pressurization of the various portions of the coating system 100 is only exemplary. For instance, the surge tank 114 could be eliminated in certain cases, with the pump 122 directly evacuating the cavity 130. Or both valves 118, 126 on the vacuum side of the system could be open while the pump is energized. In another example, the surge tank valve 118 may remain open when the coating valve 112 is opened, with some of the coating material flowing from the coating port 104 to the vacuum port 106 and collected in a trap before the surge tank, for example. Various other arrangements are possible. For instance, some embodiments of the coating system 100 include a plurality of coating ports 104 distributed along the closure 102 for a more even distribution of the coating material during the coating step of FIG. 6.

A method of making a vehicle interior panel may thus include providing a layer of plasticized polymeric material, consistent with that described above, and vacuum coating the layer of plasticized polymeric material with a barrier material, where the layer of plasticized polymeric material forms at least a portion of the decorative skin layer of the interior panel. The method may be performed by the illustrated system 100, or by some other system or process. For example, some other type of vacuum coating system may be employed that does not required the layer of plasticized polymer material to be on the molding tool that formed it during the vacuum coating process. In other words, the molded layer could be removed from the molding tool prior to vacuum coating. In another embodiment, the layer of molded material remains on the molding tool, but it is not necessarily a slush molding tool—i.e., it could be a thermoforming or vacuum forming tool, for example. The method may further include disposing the vacuum-coated layer of material over a substrate to form the vehicle interior panel, with or without a foam layer between the barrier material and the substrate. Where a foam layer is included, it may be formed in a foam-in-place process or otherwise attached or formed between the skin layer and substrate.

It is also contemplated that with the advent of using the molding tool for processes other than molding, such as the illustrated vacuum coating process, the molding tool may be used to make multi-layer materials via processes other than vacuum coating and may be used to deposit non-barrier backing layers. A method of making an interior panel for a vehicle may thus include slush molding a layer of the interior panel on a slush molding tool surface, disposing a backing layer over the slush molded layer while the slush molded layer is on the slush molding tool surface to form a multi-layer material on the slush molding tool surface, and removing the multi-layer material from the slush molding tool surface. The backing layer is formed from a material different from the slush molded layer and does not necessarily include a barrier material. The multi-layer material is configured to be disposed over a substrate as part of the interior panel. This represents a new and unconventional used of a slush molding tool to form a multi-layer material for a vehicle interior panel. For instance, the first layer molded on the molding tool surface may include the desired colorant, texture, or softness, with the backing layer being a less expensive version of a similar material—i.e., without colorant or with recycled content.

The backing layer could be painted on, vacuum coated onto the slush molded layer, or even slush molded onto the first slush molded layer. The method benefits from adding the backing layer prior to demolding—i.e., while the layer is still in its desired shape before demolding. As noted above, once demolded, many skin layer materials are too flexible to support their own weight and be handled in a manufacturing environment for such post processes. Disposing the backing layer while the slush molded layer is still on the molding tool allows access to disposed the backing layer along undercut features, for example, particularly in a vacuum coating operation, whether or not the backing layer contains a barrier material. The method also represents an unconventional static use of a slush molding tool. In other words, a slush molding tool is used to form a material layer of a vehicle interior panel without an attached powder box and without rotation or inversion of the molding tool to distribute the desired material over the molding surface to achieve the desired shape.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of making an interior panel for a vehicle, comprising the steps of:
a) providing a layer of plasticized polymeric material comprising a polymeric material and a plasticizer distributed within the polymeric material; and
b) vacuum coating the layer of plasticized polymeric material with a barrier material, the plasticizer having a solubility in the barrier material that is less than a solubility of the plasticizer in the polymeric material,
wherein the layer of plasticized polymeric material forms at least a portion of a decorative skin layer of the interior panel.

2. The method of claim 1, wherein the layer of plasticized polymeric material is formed by slush molding and has an outer side formed on a slush molding tool surface and an opposite inner side that is vacuum coated in step b).

3. The method of claim 1, further comprising the steps of:
molding the layer of plasticized polymeric material on a molding tool surface in step a); and
removing the layer of plasticized polymeric material from the molding tool surface, wherein step b) is performed before the step of removing.

4. The method of claim 1, wherein step b) comprises powder coating the layer of plasticized polymeric material with the barrier material.

5. The method of claim 1, further comprising the step of disposing the vacuum coated layer of material over a substrate to form the interior panel.

6. The method of claim 5, further comprising the step of disposing a foam layer between the substrate and the barrier material.

7. The method of claim 6, wherein the step of disposing the foam layer comprises a foam-in-place process.

8. The method of claim 1, wherein the barrier material comprises a cross-linked polymeric material.

9. The method of claim 1, wherein the barrier material comprises a semi-crystalline polymeric material.

10. A method of making an interior panel for a vehicle, comprising the steps of:
a) slush molding a layer of the interior panel on a slush molding tool surface;
b) disposing a backing layer over the slush molded layer while the slush molded layer is on the slush molding tool surface to form a multi-layer material on the slush molding tool surface, wherein the backing layer is formed from a material different from the slush molded layer; and
c) removing the multi-layer material from the slush molding tool surface,
wherein the multi-layer material is configured to be disposed over a substrate as part of the interior panel.

11. The method of claim 10, wherein the slush molded layer comprises a plasticized polymeric material and the backing layer comprises a barrier material, a plasticizer of the plasticized polymeric material being less soluble in the barrier material than in a polymeric material of the plasticized polymeric material.

12. The method of claim 10, wherein step b) comprises the step of vacuum coating the backing layer over the slush molded layer.

13. The method of claim 10, wherein step b) comprises the step of powder coating an exposed side of the slush molded layer.

14. The method of claim 13, wherein the step of powder coating does not include rotational slush molding.

15. The method of claim 10, further comprising the step of disposing the multi-layer material over the substrate as part of the interior panel.

16. The method of claim 15, further comprising the step of disposing a foam layer between the substrate and the multi-layer material.

17. The method of claim 16, wherein the step of disposing the foam layer comprises a foam-in-place process.

18. The method of claim 10, wherein the backing layer comprises a cross-linked polymeric material.

19. The method of claim 10, wherein the backing layer comprises a semi-crystalline polymeric material.
